(19) United States
(12) Patent Application Publication
(10) Pub. No.: US 2018/0166715 A1
(43) Pub. Date: Jun. 14, 2018

(54) FUEL CELL SYSTEM AND STARTUP AND SHUTDOWN METHOD THEREFOR

(71) Applicant: Asia Pacific Fuel Cell Technologies, Ltd., Zhunan (TW)

(72) Inventors: Jefferson YS Yang, Orange, CA (US); Fang-Bor Weng, Zhunan (TW); Chih-Kai Cheng, Zhunan (TW); Tzu-Wei Kuo, Zhunan (TW)

(21) Appl. No.: 15/620,047

(22) Filed: Jun. 12, 2017

(30) Foreign Application Priority Data
Dec. 13, 2016 (TW) 105141234

(51) Int. Cl. H01M 8/04223; H01M 8/04082; H01M 8/04694

(52) U.S. Cl. CPC H01M 8/04223; H01M 8/04694; H01M 8/04082

(57) ABSTRACT

The present invention provides a fuel cell system and a startup and shutdown method therefor for avoiding carbon corrosion. The fuel cell system includes at least one fuel cell reaction module with at least one anode chamber to contain an anode reaction fluid. The method includes steps of: (a) executing a shutdown mode, (b) conducting and connecting a first load to the fuel cell reaction module so as to consume the anode reaction fluid remained in the anode chamber, (c) providing a buffer fluid to the anode chamber and disconnecting the first load from the anode chamber; (d) maintaining the fuel cell system shutdown, (e) executing a startup mode, (f) providing the anode reaction fluid to the anode chamber, and (g) conducting and connecting a second load to the fuel cell reaction module and maintaining the fuel cell system operated continuously.

### FIELD OF THE INVENTION

The present invention relates to a fuel cell system, and more particularly to a fuel cell system and a startup and shutdown method therefor for avoiding carbon corrosion.

### BACKGROUND OF THE INVENTION

Fuel cells are well known and widely utilized to produce the electrical energy from a reduction-oxidation reaction of a hydrogen containing reducing agent and an oxygen containing oxidizing agent, so as to provide the power to an electrical apparatus or an application device, such as 3C products or transportation vehicles, etc. However, in a conventional fuel cell, it has been discovered that the carbon corrosion takes place in the catalyst layers of electrodes during the startup procedure, and that corrosion leads to lose the performance of the fuel cells.

While the conventional fuel cell is starting up, there is the air contained in both of the anode catalyst layer and the cathode catalyst layer. Furthermore, a proton exchange membrane (PEM) as an electrolyte is disposed between the anode catalyst layer and cathode catalyst layer. The oxygen containing oxidizing agent is introduced to flow through a cathode chamber so that the oxidizing agent flows adjacent to the cathode catalyst layer. At the same time, a hydrogen containing fuel fluid is introduced to flow through an anode chamber so that the hydrogen containing fuel fluid flows adjacent to the anode catalyst layer. While the hydrogen containing fuel fluid flows through the anode chamber, there is a fuel-air front created to move along the anode catalyst layer until the fuel forces all of the air out of the anode chamber. It has been observed that the catalyst layer opposite to the fuel-air front occurs a substantial carbon corrosion during each startup procedure of the fuel cell.

FIG. 1 is a schematic representation illustrating the electrochemical reaction of the conventional fuel cell. The fuel cell 10 includes a cathode catalyst layer 12, an anode catalyst layer 14 and the electrolyte layer 16. The cathode catalyst layer 12 includes a catalyst integrated with a carrying material, such as the platinum carried on the surfaces of a porous carbon black support. While the fuel cell 10 is performed in the startup procedure, the hydrogen containing fuel fluid is introduced to the anode catalyst layer 14 from the left-hand side region A. At the meantime, the opposite cathode catalyst layer 12 is exposed to the air. After the hydrogen containing fuel fluid is dissociated into the hydrogen ions and the electrons, the hydrogen ions pass through the electrolyte layer 16 from the anode catalyst layer 14 to the region A of the cathode catalyst layer 12. Consequently, at the cathode catalyst layer 12, those hydrogen ions participate with the oxygen in the air and the generated electrons from the reduction reaction to produce water. On the other hand, at the right-hand side region B of the fuel cell 10, the air on the anode catalyst layer 14 reacts with the electrons provided from the region A on the anode catalyst layer 14 and with the hydrogen ions or protons supplied from the opposite cathode catalyst layer 12 to form the water. Since the transmitting protons from the region B of the cathode catalyst layer 12 to the region B of the anode catalyst layer 14, and the transmitting electrons from the region B of the cathode catalyst layer 12 to the region A of the cathode catalyst layer 12, the potential of the cathode catalyst layer 12 in the region B will be raised and it also results in a reversal current different from that in a normal fuel cell operating mode. The reactions occurred in the region B of the cathode catalyst layer 12 are the corrosion of carbon to form carbon dioxide and the electrolysis of the water to form oxygen. When the hydrogen containing fuel fluid is completely used, the reactions illustrated in FIG. 1 still occur.

Obviously, the reversal current generated by the reactions in the region B of FIG. 1 will raise the local potential and rapidly degrade the carbon black support carrying the catalyst at the region B of the cathode catalyst layer 12. In practical application, after the startup-and-shutdown procedure has been performed in several dozens of cycles, 25% to 30% carbon black support with high surface area to carry the cathode catalyst layer 12 will be corroded away.

Therefore, there is a need of providing a fuel cell system and a startup and shutdown method therefor for avoiding carbon corrosion and overcoming the above drawbacks.

### SUMMARY OF THE INVENTION

An object of the present invention is to provide a fuel cell system and a startup and shutdown method therefor. The fuel cell system can control the sequences of introducing the anode reaction fluid or the buffer fluid into the anode chamber and discharging out of the anode chamber, and further provide the load in time to consume or clean the residual anode reaction fluid or the residual buffer fluid attached on the interior of the anode chamber, thereby avoiding carbon corrosion. In addition, comparing to the time-wasting startup and shutdown procedures of the prior art, the present invention provides a schedule to proceed the sequences of the vacuum evacuation, the hydrogen consumption load, the fluid supply and the fluid purification so as to greatly reduce the waste time for the startup and shutdown procedures. It is easy to be used and creates more industrial applicability.

In accordance with an aspect of the present invention, a fuel cell system is provided. The fuel cell system includes a fuel cell reaction module, a first anode fluid supply unit, a second anode fluid supply unit, a control unit, a third control valve and a shunt. The fuel cell reaction module includes at least one anode chamber. The first anode fluid supply unit includes a first control valve and is configured to provide an anode reaction fluid to the anode chamber. The second anode fluid supply unit includes a second control valve and is configured to provide a buffer fluid to the anode chamber. The control unit is connected to the first control valve and the second control valve so as to control the first control valve to introduce the anode reaction fluid to the anode chamber or control the second control valve to introduce the buffer fluid to the anode chamber, respectively. The third control valve is connected to the control unit and the anode chamber and controlled by the control unit to discharge the anode reaction fluid or the buffer fluid from the anode chamber. The shunt is connected to the fuel cell reaction module and the control unit and configured to provide a first load in a shutdown mode or a second load in a startup mode or during a continuous operation.

In accordance with another aspect of the present invention, a startup and shutdown method for a fuel cell system is provided. The fuel cell system includes at least one fuel cell reaction module and the fuel cell reaction module includes at least one anode chamber to contain an anode reaction fluid. The startup and shutdown method includes steps of: (a) executing a shutdown mode; (b) conducting and connecting a first load to the fuel cell reaction module so as to consume the anode reaction fluid remained in the anode chamber; (c) providing a buffer fluid to the anode chamber and disconnecting the first load from the anode chamber; (d) maintaining the fuel cell system shutdown; (e) executing a startup mode; (f) providing the anode reaction fluid to the anode chamber; and (g) conducting and connecting a second load to the fuel cell reaction module and maintaining the fuel cell system operated continuously.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a schematic representation illustrating the electrochemical reaction of the conventional fuel cell;

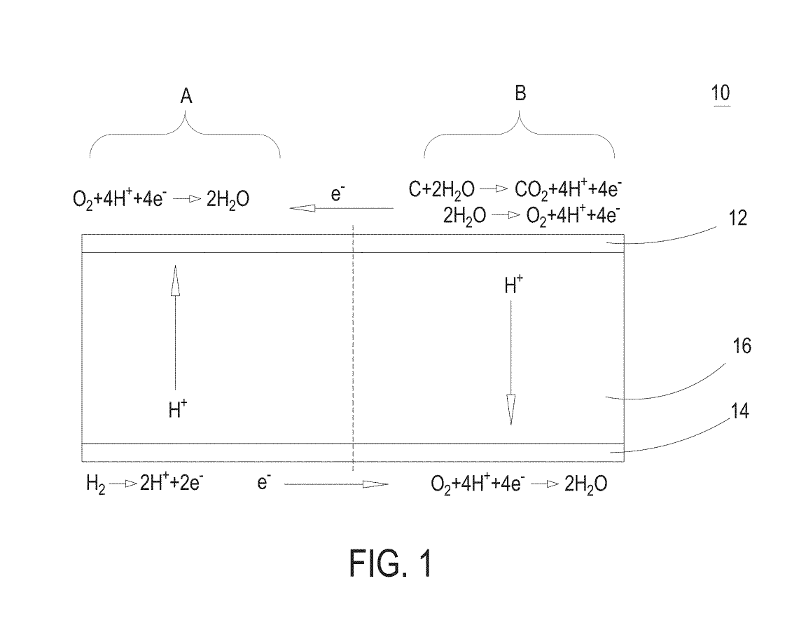

FIG. 2A is a block diagram illustrating a fuel cell system according to a first preferred embodiment of the present invention;

FIG. 2B is another exemplary block diagram illustrating the fuel cell system of FIG. 2A;

FIG. 3 is a flow chart illustrating a startup and shutdown method of the fuel cell system of FIG. 2A;

FIG. 4 is a time chart of the battery voltages and the fluid pressures at the sequences in Table 1;

FIG. 5 shows the results of the accelerated stress test for the fuel cell system of FIG. 2A;

FIG. 6 shows the change of the electrochemical surface area after the accelerated stress test in FIG. 5;

FIG. 7A is a block diagram illustrating a fuel cell system according to a second preferred embodiment of the present invention;

FIG. 7B is another exemplary block diagram illustrating the fuel cell system of FIG. 7A;

FIG. 8 is a flow chart illustrating a startup and shutdown method of the fuel cell system of FIG. 7A;

FIG. 9 is a time chart of the battery voltages and the fluid pressures at the sequences in Table 2;

FIG. 10 shows the results of the accelerated stress test for the fuel cell system of FIG. 7A; and

FIG. 11 shows the change of the electrochemical surface area after the accelerated stress test in FIG. 10.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

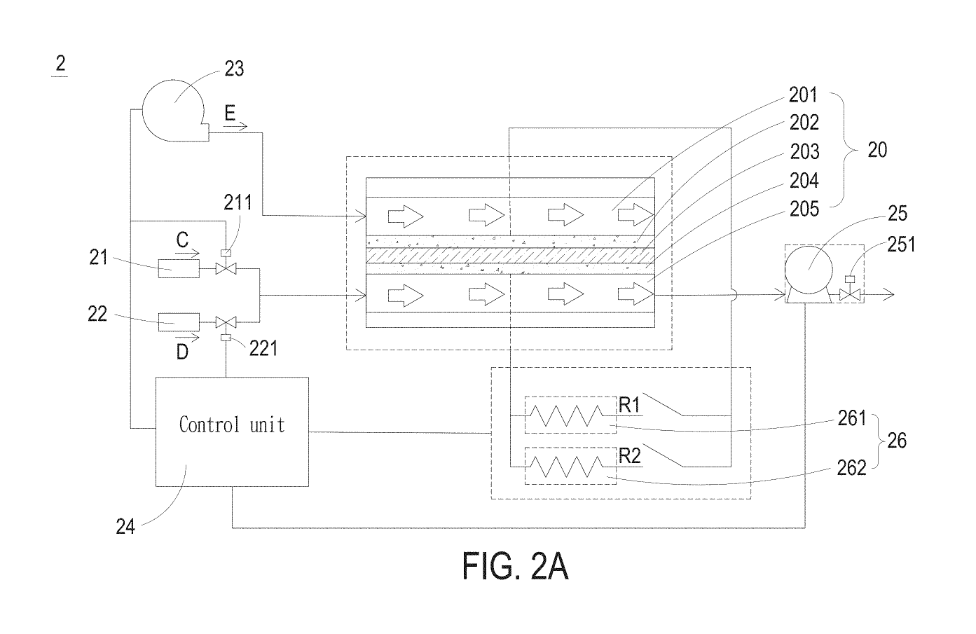

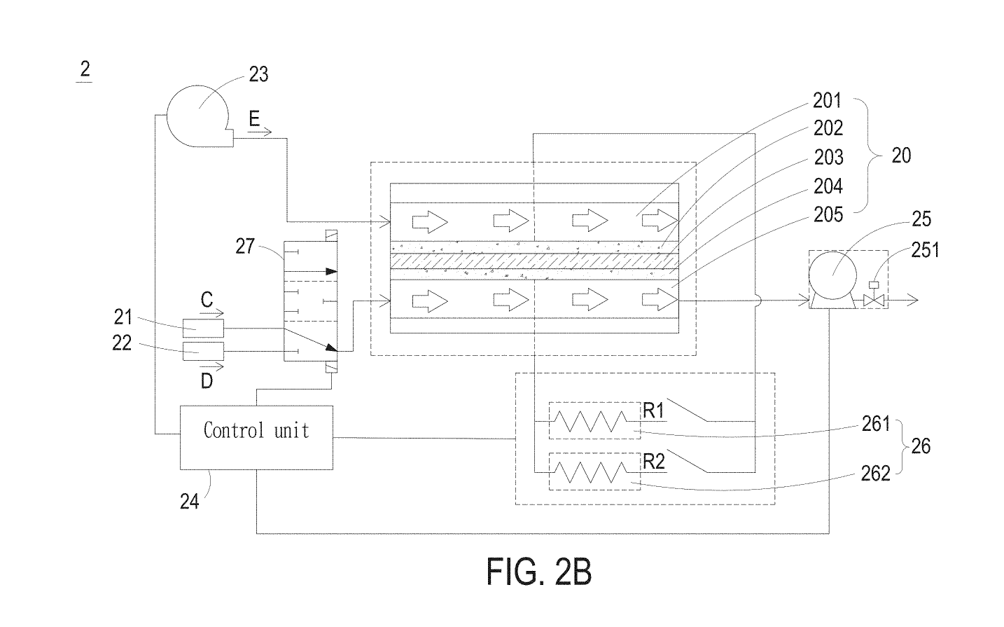

FIG. 2A is a block diagram illustrating a fuel cell system according to a first preferred embodiment of the present invention. The fuel cell system 2 at least includes a fuel cell reaction module 20, a first anode fluid supply unit 21, a second anode fluid supply unit 22, a cathode fluid supply unit 23, a control unit 24, an evacuating equipment 25 and a shunt 26. The fuel cell reaction module 20 at least includes a cathode chamber 201, a cathode catalyst layer 202, an electrolyte layer 203, an anode catalyst layer 204 and an anode chamber 205. The first anode fluid supply unit 21 includes a first control valve 211 and is configured to provide an anode reaction fluid C to the anode chamber 205. The second anode fluid supply unit 22 includes a second control valve 221 and is configured to provide a buffer fluid D to the anode chamber 205. The anode catalyst layer 204 is disposed in the anode chamber 205. The cathode fluid supply unit 23 is connected to the cathode chamber 201 of the fuel cell reaction module 20 and the control unit 24. The cathode catalyst layer 202 is disposed in the cathode chamber 201. The electrolyte layer 203 is disposed between the cathode catalyst layer 202 and the anode catalyst layer 204. The control unit 24 is connected to the first control valve 211 and the second control valve 221 to control the first control valve 211 to introduce the anode reaction fluid C into the anode chamber 205 or control the second control valve 221 to introduce the buffer fluid D into the anode chamber 205. In the embodiment, the anode reaction fluid C is a hydrogen containing fuel fluid, and the buffer fluid D and the cathode reaction fluid E supplied by the cathode fluid supply unit 23 are the air. In an embodiment, the buffer fluid D is a nitrogen or an inert gas, but the present invention is not limited thereto. In addition, the evacuating equipment 25 is connected to the anode chamber 205, the control unit 24 and a third control valve 251, and further can be driven by the control unit 24 to discharge the residual fluid of the anode chamber 205 and make the anode chamber 205 tend to a vacuum status, for example the inner pressure of the anode chamber 205 is ranged from 0 psi to −30 psi. The shunt 26 is connected to the fuel cell reaction module 20 and the control unit 24 and configured to provide a first load 261 while the fuel cell reaction module 20 is operated in a shutdown mode or a second load 262 while the fuel cell reaction module 20 is operated in a startup mode or operated continuously, so as to consume the residual anode reaction fluid C of the anode chamber 205. In the embodiment, the first load 261 includes a first shunt resistor R1, the second load 262 includes a second shunt resistor R2, and the first shunt resistor R1 is smaller the second shunt resistor R2. In particular application, the first load 261 can be for example but not limited to a vacuum pump, a hydrogen pump, a suction pump, a circulating pump, a water pump, a radiator, a blower or a DC converter. The second load 262 can be for example but not limited to a vacuum pump, a hydrogen pump, a suction pump, a circulating pump, a water pump, a radiator, a blower, a DC converter or a motor. The sequences for the first control valve 211 to introduce the anode reaction fluid C into the anode chamber 205, the second control valve 221 to introduce the buffer fluid D into the anode chamber 205, and the evacuating equipment 25 and the third control valve 251 to remove the residual anode reaction fluid C and the buffer fluid D remained in the anode chamber 205 are controlled by the control unit 24 of the fuel cell system 2. Furthermore, the first load 261 or the second load 262 of the shunt 26 is provided to consume the residual anode reaction fluid C remained in the anode chamber 205. Consequently, the purpose of avoiding carbon corrosion is achieved. It is noted that the first control valve 211 and the second control valve 221 of the above embodiment are solenoid valves, which can be integrated together and substituted by a three-way valve, for example a three-position three-way solenoid valve, so as to save the components consisted thereof. FIG. 2B is another exemplary block diagram illustrating the fuel cell system of FIG. 2A. In the embodiment, the first anode fluid supply unit 21 and the second anode fluid supply unit 22 are connected to the anode chamber 205 through a three-way valve 27. The three-way valve 27 is further connected to the control unit 24 and controlled by the control unit 24 to determine the sequences of introducing the anode reaction fluid C from the first anode fluid supply unit 21 or the buffer fluid D from the second anode fluid supply unit 22 individually or blocking the anode chamber 205 without introducing any fluid. Namely, the three-way valve 27 in FIG. 2B replaces and servers as the first control valve 211 and the second control valve 221 in FIG. 2A so as to compact the entire structure of the fuel cell system 2. Certainly, it is not an essential technical feature of the present invention, and the present invention is not limited thereto and not redundantly described herein. It should be emphasized that the above fuel cell reaction module 20 can be for example but not limited to a single cell module, a fuel cell stack consisted of single cell modules, or other forms of battery modules or modular stacks. The above evacuating equipment 25 can be for example but not limited to a vacuum pump, a hydrogen pump, a suction pump, a circulating pump or a blower.

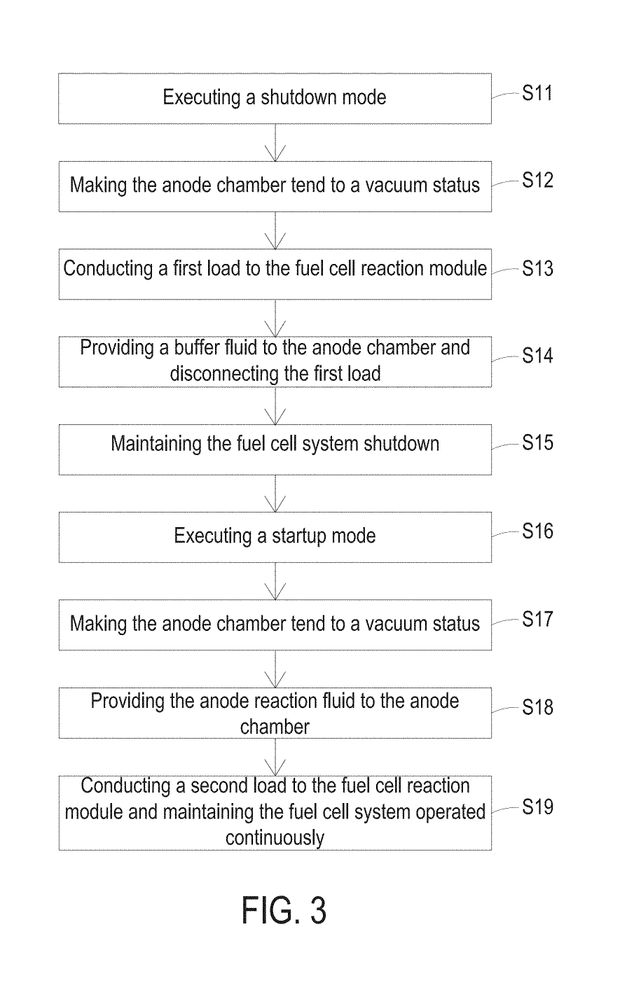

Based on the above fuel cell system 2, the present invention further provides a startup and shutdown method applied to the fuel cell system 2 for avoiding carbon corrosion. FIG. 3 is a flow chart illustrating a startup and shutdown method of the fuel cell system of FIG. 2A. The relative operating sequences of the essential components of the fuel cell system 2 are listed in Table 1. As shown in FIGS. 2A and 3 and Table 1, while the fuel cell system 2 is operated continuously to provide the power, the control unit 24 drives the first control valve 211 to be turned on (opened) and introduce the anode reaction fluid C into the anode chamber 205. At the meantime, the second control valve 221, the third control valve 251 and the evacuating equipment 25 are turned off (closed), the second load 262 of the shunt 26 is conducted and the cathode fluid supply unit 23 is turned on (opened), as shown at the sequence 7 in Table 1. While a shutdown mode is selected to execute by the user, as shown at the step S11 in FIG. 3, the control unit 24 starts to work and follows the sequences 1 to 4 in Table 1. Firstly, the first control valve 211 and the second control valve 221 are turned off (closed) and the evacuating equipment 25 and the third control valve 251 are turned on (opened) to work for 3 seconds so as to remove the residual fluid from the anode chamber 205 by means of the vacuum evacuation and make the anode chamber 205 tend to a vacuum status, as shown at the step S12. Afterward, the evacuating equipment 25 and the third control valve 251 are turned off (closed) and the first load 261 of the shunt 26 is conducted and connected to the fuel cell reaction module 20 for 5 seconds so as to consume the residual anode reaction fluid C remained in the anode chamber 205, as shown at the step S13. Then, the cathode fluid supply unit 23 is turned off (closed), the first load 261 of the shunt 26 is disconnected, and the evacuating equipment 25, the third control valve 251 and the second control valve 221 are turned on (opened) to work for 3 seconds, so as to fill the anode chamber 205 with the buffer fluid D supplied by the second anode fluid supply unit 22, as shown at the step S14. Finally, the evacuating equipment 25, the third control valve 251 and the second control valve 221 are turned off (closed) for at least 15 seconds to accomplish the shutdown procedure and maintain the shutdown status for the fuel cell system 2, as shown at the step S15. On the other hand, while a startup mode is selected to execute by the user, as shown at the step S16, the control unit 24 starts to work and follows the sequences 5 to 7 in Table 1. Firstly, the evacuating equipment 25 and the third control valve 251 are turned on (opened) to work for 3 seconds so as to remove the residual buffer fluid D from the anode chamber 205 by means of the vacuum evacuation and make the anode chamber 205 tend to a vacuum status, as shown at the step S17. Then, the first control valve 211 is turned on (opened) to work for 3 seconds so as to introduce the anode reaction fluid C supplied by the first anode fluid supply unit 21 into the anode chamber 205. At the meantime, the cathode fluid supply unit 23 is turned on (opened) to provide the cathode reaction fluid E to the cathode chamber 201 as shown at the step S18. Finally, the evacuating equipment 25 and the third control valve 251 are turned off (closed) and the second load 262 of the shunt 26 is conducted and connected to the fuel cell reaction module 20 for at least 15 seconds to accomplish the startup procedure and maintain the fuel cell system 2 operated continuously, as shown at the step S19. Consequently, the fuel cell system 2 can maintain the stable reactions thereof and provide the power continuously.

Table 1 lists the relative operating sequences of the essential components of the fuel cell system 2.

| | | | | | | | | The | |
|---|---|---|---|---|---|---|---|---|---|
| | | | | The | | | | cathode | |
| | | | The first | second | The third | The | | fluid | |
| | | | control | control | control | evacuating | The | supply | Time |
| Sequence | Mode | Procedure | valve | valve | valve | equipment | shunt | unit | (sec) |
| 1 | The | Vacuum | OFF | OFF | ON | ON | ON | ON | 3 |
| | shutdown | evacuation | | | | | | | |
| 2 | mode | Hydrogen | OFF | OFF | OFF | OFF | ON | ON | 5 |
| | | consumption | | | | | | | |
| | | load | | | | | | | |
| 3 | | Fluid supply | OFF | ON | ON | ON | OFF | OFF | 3 |
| 4 | | Lock | OFF | OFF | OFF | OFF | OFF | OFF | 15 |
| | | procedure | | | | | | | |
| 5 | The startup | Vacuum | OFF | OFF | ON | ON | OFF | OFF | 3 |
| | mode | evacuation | | | | | | | |
| 6 | | Fluid | ON | OFF | ON | ON | OFF | ON | 3 |
| | | purification | | | | | | | |
| 7 | | Lock | ON | OFF | OFF | OFF | ON | ON | 15 |
| | | procedure | | | | | | | |

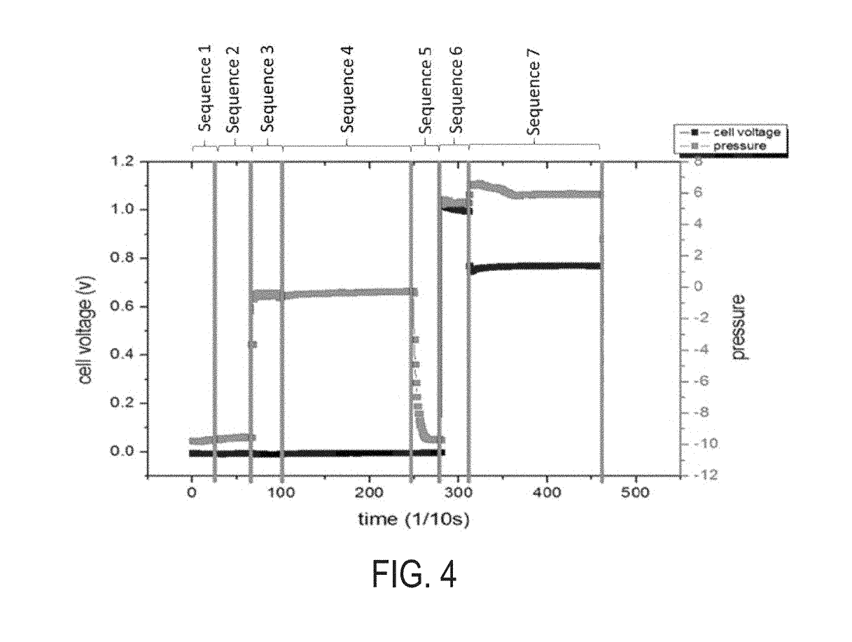

FIG. 4 is a time chart of the battery voltages and the fluid pressures at the sequences in Table 1. With referring to FIGS. 2A and 3, it is understood that the control unit 24 acts as the following steps (i.e. at the sequences 1 to 4 in Table 1) in the shutdown mode. Firstly, the first control valve 211 is turned off (closed) and the evacuating equipment 25 and the third control valve 251 are turned on (opened) to remove the residual anode reaction fluid C from the anode chamber 205 by means of the vacuum evacuation so as to make the anode chamber 205 tend to a vacuum status, as shown at the sequence 1 in Table 1 and FIG. 4. Afterward, the first load 261 of the shunt 26 is conducted and connected to serve the hydrogen consumption load to consume the residual anode reaction fluid C remained in the anode chamber 205 and the anode chamber 205 is maintained in the vacuum status, as shown at the sequence 2 in Table 1 and FIG. 4. Then, the second control valve 221 is turned on (opened) to introduce the buffer fluid D into the anode chamber 205 and fill the anode chamber 205 with the buffer fluid D, as shown at the sequence 3 in Table 1 and FIG. 4. Finally, the fuel cell system 2 is locked with the procedure lock and maintained in the shutdown status, as shown at the sequence 4 in Table 1 and FIG. 4, and thus the buffer fluid D is kept in the anode chamber 205 for protection. On the other hand, while the fuel cell reaction module 20 is restarted, the control unit 24 of the fuel cell system 2 acts as the following steps (i.e. at the sequences 5 to 7 in Table 1) in the startup mode. Firstly, the evacuating equipment 25 and the third control valve 251 are turned on (opened) to remove the residual buffer fluid D from the anode chamber 205 so as to make the anode chamber 205 tend to a vacuum status, as shown at the sequence 5 in Table 1 and FIG. 4. Then, the first control valve 211 is turned on (opened) to introduce the anode reaction fluid C into the anode chamber 205 so as to accomplish the fluid purification, as shown at the sequence 6 in Table 1 and FIG. 4. At the meantime, the anode chamber 205 and the anode catalyst layer 204 are full of the anode reaction fluid C. Finally, the second load 262 of the shunt 26 is conducted and connected to the fuel cell reaction module 20 and the fuel cell system 2 is locked with the procedure look to accomplish the startup procedure and maintain the fuel cell system operated continuously, as shown at the sequence 7 in Table 1 and FIG. 4. The anode reaction fluid C is supplied continuously to the anode catalyst layer 204 from the anode chamber 205 for the reaction. According to the above descriptions, it is understood that the fuel cell system 2 can control the sequences of driving the first control valve 211 to introduce the anode reaction fluid C into the anode chamber 205, driving the second control valve 221 to introduce the buffer fluid D into the anode chamber 205, and driving the evacuating equipment 25 and the third control valve 251 to remove the residual anode reaction fluid C or the buffer fluid D away from the anode chamber 205, and the fuel cell system 2 further provides the first load 261 or the second load 262 of the shunt 26 in time to consume the residual anode reaction fluid C attached on the interior of the anode chamber 205. Consequently, the purpose of avoiding carbon corrosion is achieved and it saves time at the startup and shutdown procedures.

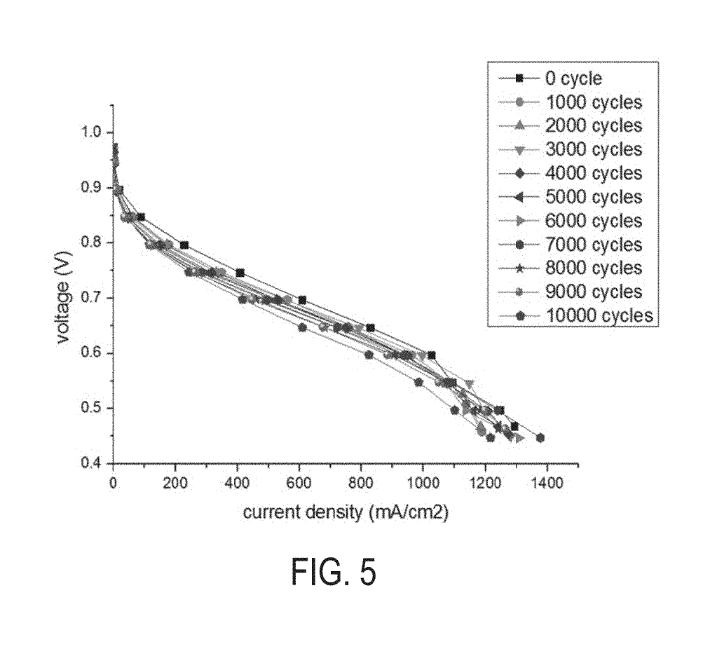

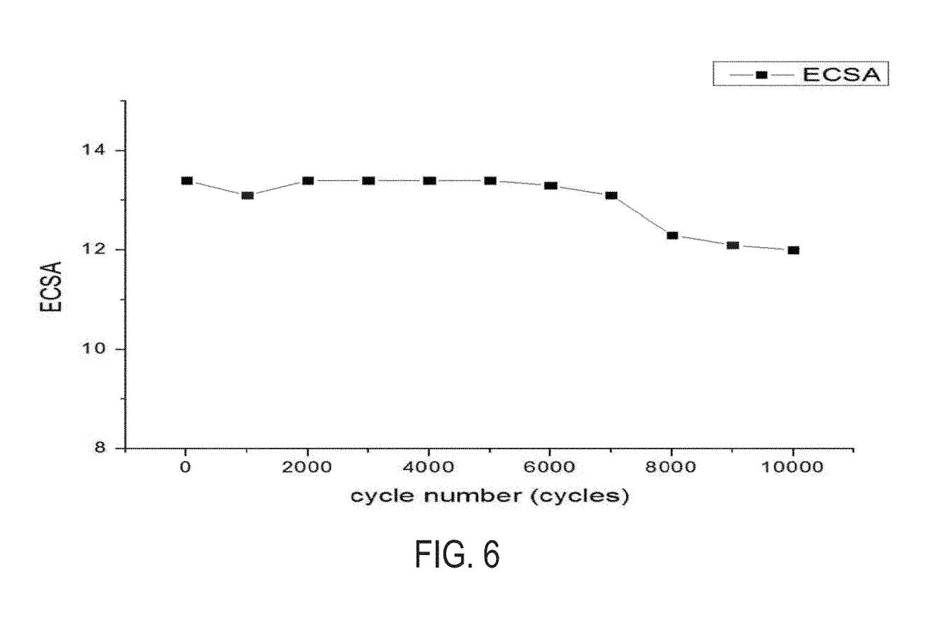

FIG. 5 shows the results of the accelerated stress test for the fuel cell system of FIG. 2A. The accelerated stress test (AST) is performed under the conditions of the reaction temperature at 65 □ and the relative humidity at 50%. While the fuel cell system 2 has executed the startup/shutdown procedures after 10000 cycles, the battery voltage is degraded from 0.75 V to 0.72 V with the current density of 400 (mA/cm²). The efficiency is reduced about 3% to 4% merely. Alternatively, the battery voltage is degraded from 0.6 V to 0.54 V with the current density of 1000 (mA/cm²). The efficiency is reduced about 10% merely. In addition, FIG. 6 shows the change of the electrochemical surface area (ECSA) of the fuel cell system 2 after the accelerated stress test in FIG. 5. As shown in FIG. 6, while the fuel cell system 2 has executed the startup/shutdown procedures after 10000 cycles, the ECSA isn't reduced apparently. Namely, the fuel cell system 2 of the present invention can control the sequences of introducing the anode reaction fluid C or the buffer fluid D into the anode chamber 205 and the order of the proceeding sequences, and the fuel cell system 2 further provides the first load 261 or the second load 262 of the shunt 26 in time to consume the residual anode reaction fluid C or the residual buffer fluid D attached on the interior of the anode chamber 205. It is obviously that the carbon corrosion can be avoided effectively. In addition, comparing to the time-wasting startup and shutdown procedures of the prior art, the present invention provides a schedule to proceed the sequences of the vacuum evacuation, the hydrogen consumption load, the fluid supply and the fluid purification so as to greatly reduce the waste time for the startup and shutdown procedures. The startup and shutdown procedures are accomplished in several tens of seconds. It is easy to be used and creates more industrial applicability.

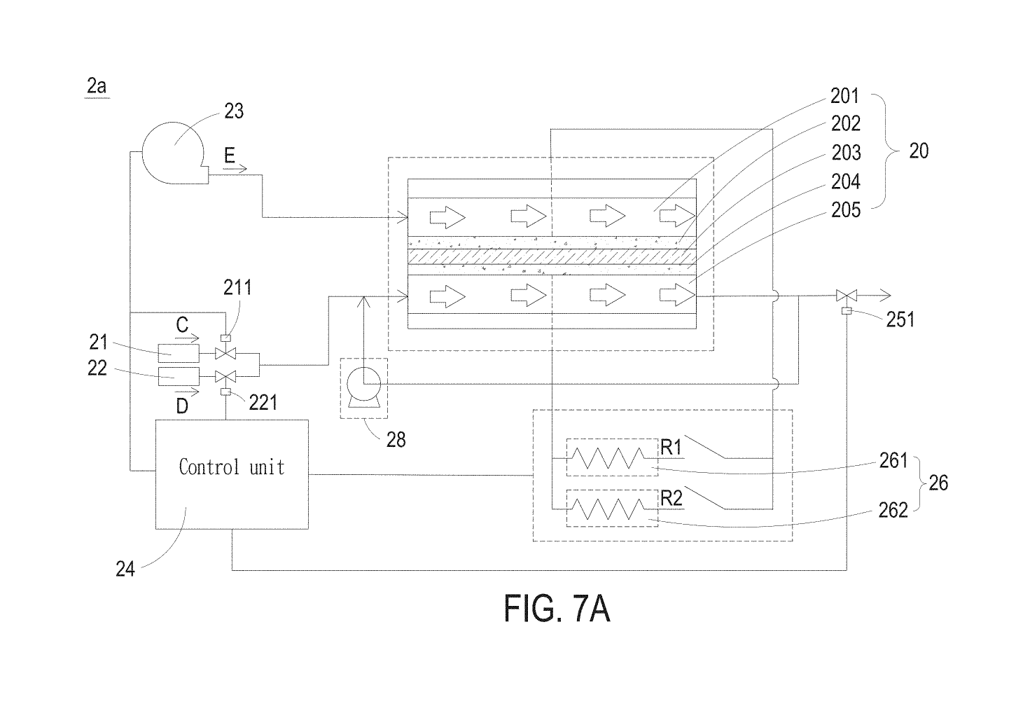

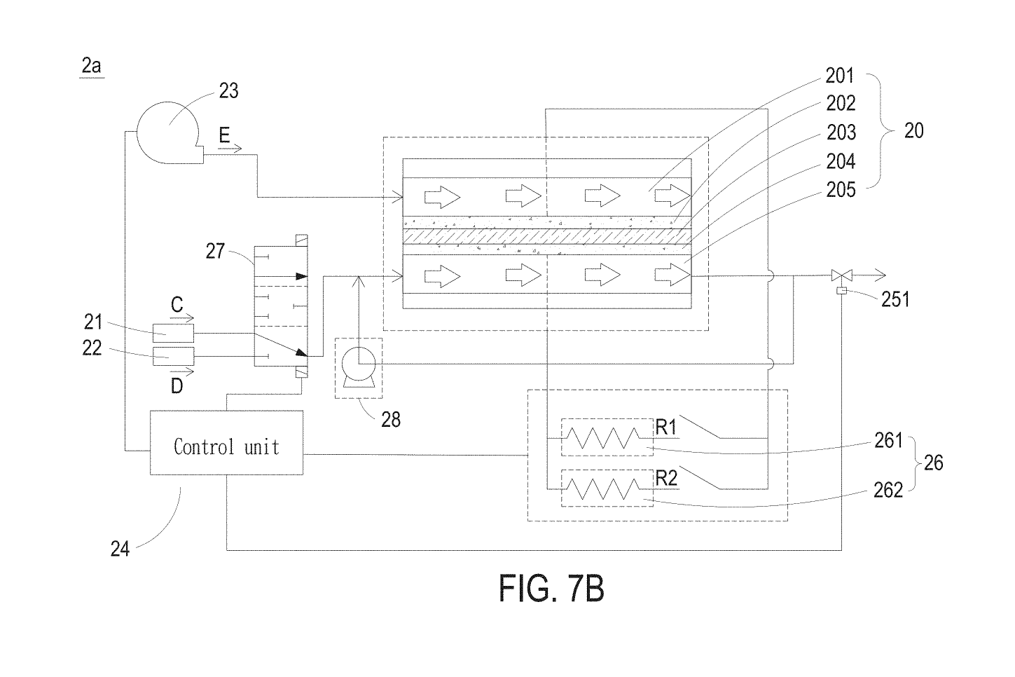

FIG. 7A is a block diagram illustrating a fuel cell system according to a second preferred embodiment of the present invention. In the embodiment, the structures, elements and functions of the fuel cell system 2a are similar to those of the fuel cell system 2 in FIG. 2A, and are not redundantly described herein. Different from the fuel cell system 2 in FIG. 2A, the fuel cell system 2a omits the evacuating equipment 25. Furthermore, in the embodiment, the fuel cell system 2a includes a recycle unit 28, which can be constructed by for example but not limited to a hydrogen pump or a blower, connected to the connection pipe between the second control valve 221 and the anode chamber 205 and the connection pipe between the anode chamber 205 and the third control valve 251, and configured to recycle the unreacted anode reaction fluid C and lead back the recycled anode reaction fluid C to the anode chamber 205, so as to recycle the anode reaction fluid C and reduce the cost of the fuel material. Certainly, it is not an essential feature to limit the present invention. The fuel cell system 2a also controls the order of the sequences to introduce the anode reaction fluid C or the buffer fluid D into the anode chamber 205 and the order of the proceeding sequences, and further provides the first load 261 or the second load 262 of the shunt 26 in time to consume the residual anode reaction fluid C or the residual buffer fluid D attached on the interior of the anode chamber 205, thereby achieving the purpose of avoiding carbon corrosion. In another exemplary embodiment, the first control valve 211 and the second control valve 221 of the above embodiment can be for example but not limited to a solenoid valve, which can be integrated together and substituted by a three-way valve, for example a three-position three-way solenoid valve, so as to save the components consisted thereof. FIG. 7B is another exemplary block diagram illustrating the fuel cell system of FIG. 7A. In the embodiment, the first anode fluid supply unit 21 and the second anode fluid supply unit 22 are connected to the anode chamber 205 through a three-way valve 27. The three-way valve 27 is further connected to the control unit 24 and controlled by the control unit 24 to determine the sequences of introducing the anode reaction fluid C from the first anode fluid supply unit 21 or the buffer fluid D from the second anode fluid supply unit 22 individually or blocking the anode chamber 205 without introducing any fluid. Namely, the three-way valve 27 of FIG. 7B replaces and servers as the first control valve 211 and the second control valve 221 of FIG. 7A so as to compact the entire structure of the fuel cell system 2a. In other embodiments, the first control valve 211, the second control valve 221, the recycle unit 28 and the anode chamber 205 are communicated to work or replaced by a multi-position multi-way solenoid valve so as to be integrated together. However, it is not an essential feature of the present invention. The present invention is not limited thereto and not redundantly described herein.

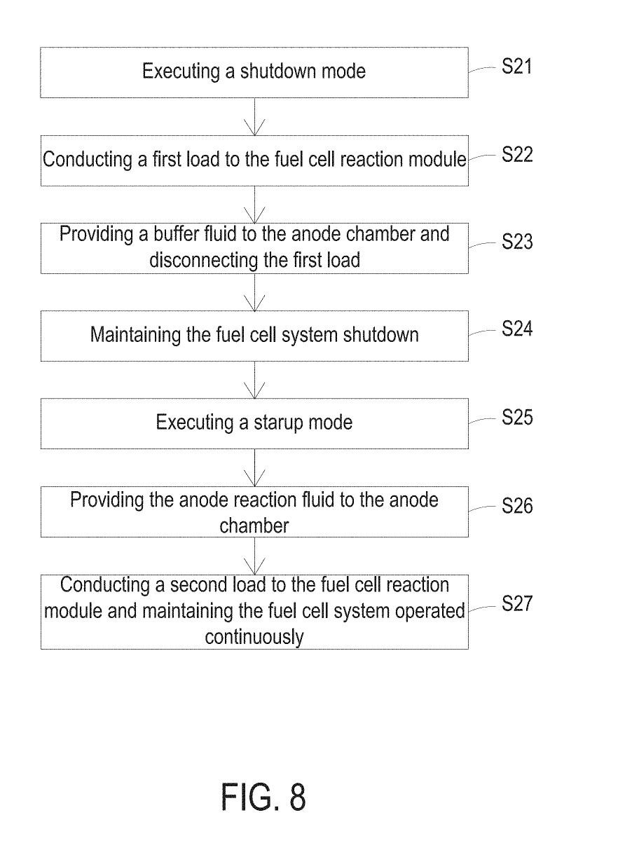

FIG. 8 is a flow chart illustrating a startup and shutdown method of the fuel cell system of FIG. 7A. The relative operating sequences of the essential components of the fuel cell system 2a are listed in Table 2. As shown in FIGS. 7A and 8 and Table 2, while the fuel cell system 2a is working continuously to provide the power, the control unit 24 drives the first control valve 211 to be turned on (opened) and introduce the anode reaction fluid C into the anode chamber 205. At the meantime, the second control valve 221 and the third control valve 251 are turned off (closed), the second load 262 of the shunt 26 is conducted and the cathode fluid supply unit 23 is turned on (opened), as shown at the sequence 5 in Table 2. While a shutdown mode is selected to execute by the user, as shown at the step S21 of FIG. 8, the control unit 24 starts to work and follows the sequences 1 to 3 in Table 2. Firstly, the first control valve 211 is turned off (closed) and the first load 261 of the shunt 26 is conducted and connected to the fuel cell reaction module 20 for 5 seconds so as to consume the residual anode reaction fluid C remained in the anode chamber 205, as shown at the step S22. Then, the cathode fluid supply unit 23 is turned off (closed), the first load 261 of the shunt 26 is disconnected, and the third control valve 251 and the second control valve 221 are turned on (opened) to work for 3 seconds, so as to fill the anode chamber 205 with the buffer fluid D supplied by the second anode fluid supply unit 22 and purge the residual anode reaction fluid C out of the anode chamber 205, as shown at the step S23. Finally, the third control valve 251 and the second control valve 221 are turned off (closed) for at least 15 seconds to accomplish the shutdown procedure and maintain the shutdown status for the fuel cell system 2a, as shown at the step S24. On the other hand, while a startup mode is selected to execute by the user, as shown at the step S25, the control unit 24 starts to work and follows the sequences 4 to 5 in Table 2. Firstly, the first control valve 211 and the third control valve 251 are turned on (opened) to work for 3 seconds so as to introduce the anode reaction fluid C supplied by the first anode fluid supply unit 21 into the anode chamber 205 and purge the residual buffer fluid D out of the anode chamber 205. At the meantime, the cathode fluid supply unit 23 is opened to provide the cathode reaction fluid E to the cathode chamber 201, as shown at the step S26. Finally, the third control valve 251 is turned off (closed) and the second load 262 of the shunt 26 is conducted and connected to the fuel cell reaction module 20 for at least 15 seconds to accomplish the startup procedure and maintain the fuel cell system 2a operated continuously, as shown at the step S27. Consequently, the fuel cell system 2a can maintain the stable reactions thereof and provide the power continuously.

Table 2 lists the relative operating sequences of the essential components of the fuel cell system 2a.

| | | | | | | | The | |
|---|---|---|---|---|---|---|---|---|
| | | | | The | | | cathode | |
| | | | The first | second | The third | | fluid | |
| | | | control | control | control | The | supply | Time |
| Sequence | Mode | Procedure | valve | valve | valve | shunt | unit | (sec) |
| 1 | The | Hydrogen | OFF | OFF | OFF | ON | ON | 5 |
| | shutdown | consumption | | | | | | |
| | mode | load | | | | | | |
| 2 | | Fluid supply | OFF | ON | ON | OFF | OFF | 3 |
| 3 | | Lock procedure | OFF | OFF | OFF | OFF | OFF | 15 |
| 4 | The | Fluid | ON | OFF | ON | OFF | ON | 3 |
| | startup | purification | | | | | | |
| 5 | mode | Lock procedure | ON | OFF | OFF | ON | ON | 15 |

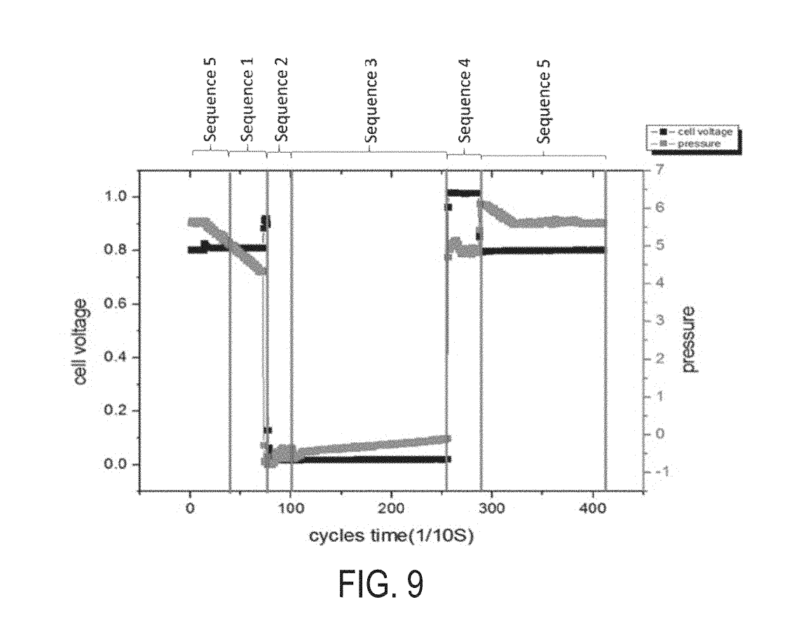

FIG. 9 is a time chart of the battery voltages and the fluid pressures at the sequences in Table 2. With referring to FIGS. 7A and 8, it is understood that the control unit 24 acts as the following steps (i.e. at the sequences 1 to 3 in Table 2) in the shutdown mode. Firstly, the first control valve 211 is closed and the first load 261 of the shunt 26 is conducted and connected to serve the hydrogen consumption load to consume the residual anode reaction fluid C remained in the anode chamber 205. Afterward, the shunt 26 and the cathode fluid supply unit 23 are disconnected, and the second control 221 and the third control valve 251 are turned on (opened) to introduce the buffer fluid D from the second anode fluid supply unit 22 to the anode chamber 205 and purge the residual anode reaction fluid C out of the anode chamber 205, so that the anode chamber 205 is filled with the buffer fluid D merely and the pressure therein is a few lower than the atmospheric pressure, as shown at the sequence 2 in Table 2 and FIG. 9. Then, the second control valve 221 and the third control valve 251 are turned off (closed), and the fuel cell system 2a is locked with the procedure lock and maintained in the shutdown status, as shown at the sequence 3 of Table 2 and FIG. 9, and thus the buffer fluid D is kept in the anode chamber 205 for protection. On the other hand, while the fuel cell system 2a is started up, the control unit 24 of the fuel cell system 2a acts as the following steps (i.e. at the sequences 4 to 5 in Table 2) in the startup mode. Firstly, the first control valve 211 and the third control valve 251 are turned on (opened) to introduce the anode reaction fluid C from the first anode fluid supply unit 21 into the anode chamber 205 and purge the residual buffer fluid D out of the anode chamber 205, as shown at the sequence 4 in Table 2 and FIG. 9. At the meantime, the anode chamber 205 is filled with the anode reaction fluid C merely. Then, the second load 262 of the shunt 26 is conducted and connected to the fuel cell reaction module 20 and the fuel cell system 2a is locked with the procedure look to accomplish the startup procedure and maintain the fuel cell system 2a operated continuously, as shown at the sequence 5 in Table 2 and FIG. 9. The anode reaction fluid C is supplied continuously to the anode catalyst layer 204 through the anode chamber 205 for the reaction. According to the above descriptions, it is understood that the control unit 24 of the fuel cell system 2a can control the sequences of driving the first control valve 211 to introduce the anode reaction fluid C into the anode chamber 205 or driving the second control valve 221 to introduce the buffer fluid D into the anode chamber 205, and further provide the first load 261 or the second load 262 of the shunt 26 in time to consume the residual anode reaction fluid C or the residual buffer fluid D attached on the interior of the anode chamber 205, thereby avoiding carbon corrosion. In the other words, the present invention integrates the shutdown procedures with the sequences of the fluid supply and the hydrogen consumption load and the startup procedures with the fluid purification, so as to achieve the purpose of effectively reducing the carbon corrosion and greatly reduce the waste time for the startup and shutdown procedures.

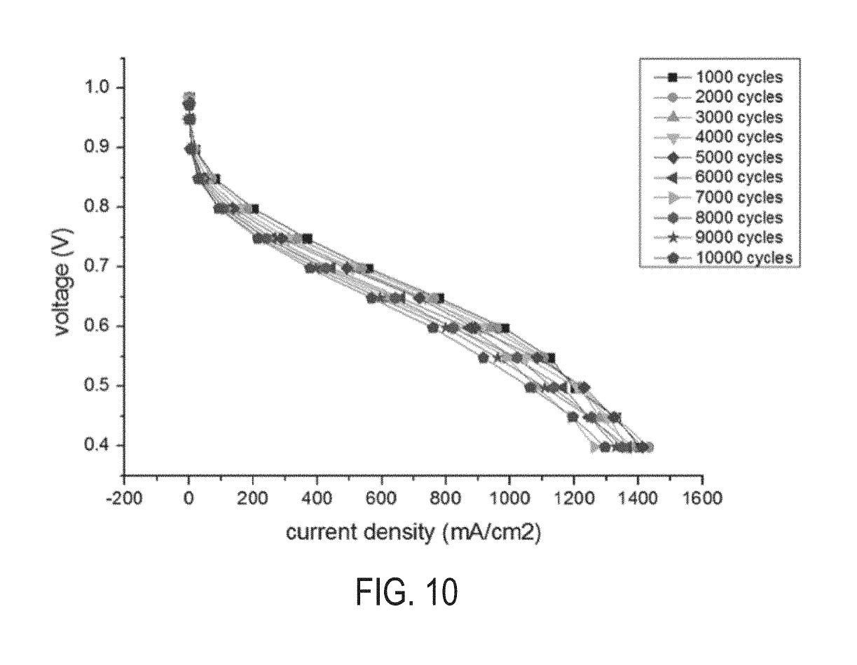

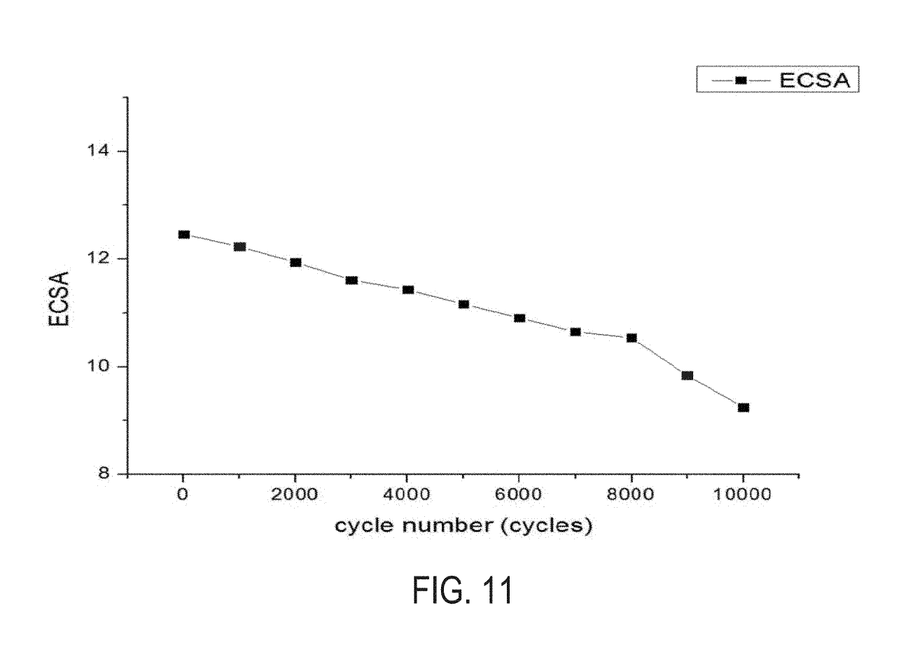

FIG. 10 shows the results of the accelerated stress test for the fuel cell system of FIG. 7A. The accelerated stress test (AST) is performed under the conditions of the reaction temperature at 65 □ and the relative humidity at 50%. While the fuel cell system 2a has executed the startup/shutdown procedures after 10000 cycles, the battery voltage is degraded from 0.74 V to 0.68 V with the current density of 400 (mA/cm²). The efficiency is reduced about 7% merely. In addition, FIG. 11 shows the change of the electrochemical surface area (ECSA) of the fuel cell system 2a after the accelerated stress test in FIG. 10. As shown in FIG. 11, while the fuel cell system 2a has executed the startup/shutdown procedures after 10000 cycles, the ECSA isn't reduced by more than 25%. Namely, the fuel cell system 2a of the present invention can control the sequences of introducing the anode reaction fluid C or the buffer fluid D into the anode chamber 205 and the order of the proceeding sequences, and further provide the first load 261 or the second load 262 of the shunt 26 in time to consume the residual anode reaction fluid C or the residual buffer fluid D attached on the interior of the anode chamber 205. It is obviously that the carbon corrosion can be avoided effectively.

It is noted that the temperature, the humidity and the operating time at the sequences of the above embodiments are merely illustrative. In practical application, the operating parameters at each control sequence are adjustable according to the number of battery packs, the system and the field environment so as to obtain the optimized parameters. It should be emphasized that any similar structural system or proceeding sequences provided to accomplish the anode gas exchange rapidly and safely and accomplish the startup and shutdown procedures rapidly with a low carbon corrosion in accordance with the concept of the present invention are included within the spirit and scope of the present invention.

In summary, the present disclosure provides a fuel cell system and a startup and shutdown method therefor. The fuel cell system can control the sequences of introducing the anode reaction fluid or the buffer fluid into the anode chamber and the order of the proceeding sequences, and further provide the load in time to consume or clean the residual anode reaction fluid or the residual buffer fluid attached on the interior of the anode chamber, thereby avoiding carbon corrosion. In addition, comparing to the time-wasting startup and shutdown procedures of the prior art, the present invention provides a schedule to proceed the sequences of the vacuum evacuation, the hydrogen consumption load, the fluid supply and the fluid purification so as to greatly reduce the waste time for the startup and shutdown procedures. It is easy to be used and creates more industrial applicability.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A fuel cell system, comprising:
a fuel cell reaction module including at least one anode chamber;
a first anode fluid supply unit including a first control valve and configured to provide an anode reaction fluid to the anode chamber;
a second anode fluid supply unit including a second control valve and configured to provide a buffer fluid to the anode chamber;
a control unit connected to the first control valve and the second control valve so as to control the first control valve to introduce the anode reaction fluid to the anode chamber or control the second control valve to introduce the buffer fluid to the anode chamber, respectively;
a third control valve connected to the control unit and the anode chamber and controlled by the control unit to discharge the anode reaction fluid or the buffer fluid from the anode chamber; and
a shunt connected to the fuel cell reaction module and the control unit and configured to provide a first load in a shutdown mode or a second load in a startup mode or during a continuous operation.

2. The fuel cell system according to claim 1, wherein the first load is one selected from a group consisting of a first shunt resistor, a vacuum pump, a hydrogen pump, a suction pump, a circulating pump, a water pump, a radiator, a blower and a DC converter, wherein the second load is one selected from a group consisting of a second shunt resistor, a vacuum pump, a hydrogen pump, a suction pump, a circulating pump, a water pump, a radiator, a blower, a DC converter and a motor, wherein the first shunt resistor is smaller the second shunt resistor.

3. The fuel cell system according to claim 1, further comprising an evacuating equipment connected to the third control valve and the control unit and controlled by the control unit to discharge the anode reaction fluid or the buffer fluid through the third control valve and make the anode chamber tend to a vacuum status.

4. The fuel cell system according to claim 3, the evacuating equipment is one selected from a group consisting of a vacuum pump, a hydrogen pump, a suction pump, a circulating pump and a blower.

5. The fuel cell system according to claim 1, wherein the anode reaction fluid is a hydrogen containing fuel fluid, and the buffer fluid is an air, a nitrogen or an inert gas.

6. A startup and shutdown method for a fuel cell system, wherein the fuel cell system comprises at least one fuel cell reaction module and the fuel cell reaction module comprises at least one anode chamber to contain an anode reaction fluid, the method comprising steps of:
(a) executing a shutdown mode;
(b) conducting and connecting a first load to the fuel cell reaction module so as to consume the anode reaction fluid remained in the anode chamber;
(c) providing a buffer fluid to the anode chamber and disconnecting the first load from the anode chamber;
(d) maintaining the fuel cell system shutdown;
(e) executing a startup mode;
(f) providing the anode reaction fluid to the anode chamber; and
(g) conducting and connecting a second load to the fuel cell reaction module and maintaining the fuel cell system operated continuously.

7. The startup and shutdown method according to claim 6, wherein the fuel cell system further comprises a shunt including a first shunt resistor and a second shunt resistor to serve as the first load and the second load, respectively, wherein the first shunt resistor is smaller the second shunt resistor.

8. The startup and shutdown method according to claim 6, wherein the step (b) further comprises a pre-step of (b1) making the anode chamber tend to a vacuum status.

9. The startup and shutdown method according to claim 6, wherein the step (f) further comprises a pre-step of (f1) making the anode chamber tend to a vacuum status.

10. The startup and shutdown method according to claim 6, wherein the anode reaction fluid is a hydrogen containing fuel fluid, and the buffer fluid is an air, a nitrogen or an inert gas.

11. The startup and shutdown method according to claim 6, wherein the fuel cell system further comprises an evacuating equipment connected to the anode chamber and the evacuating equipment is one selected from a group consisting of a vacuum pump, a hydrogen pump, a suction pump, a circulating pump and a blower.
